(19) United States
(12) Patent Application Publication
(10) Pub. No.: US 2023/0382497 A1
(43) Pub. Date: Nov. 30, 2023

(54) SHIP RESISTANCE REDUCTION APPARATUS USING AIR

(71) Applicant: CORPORATION CONDENSATION STORY, Jinju-si Gyeongsangnam-do (KR)

(72) Inventor: Seong Kee Park, Sacheon-si (KR)

(21) Appl. No.: 18/032,004

(22) PCT Filed: Oct. 25, 2021
(86) PCT No.: PCT/KR2021/015000

§ 371 Date: Apr. 14, 2023

(30) Foreign Application Priority Data
Nov. 13, 2020 (KR) 10-2020-0151673

(51) Int. Cl. B63B 1/38

(52) U.S. Cl. CPC B63B 1/38; B63B 2001/387

(57) ABSTRACT

A ship resistance reduction apparatus using air is disclosed. The objective of the present invention is to spray air at the bottom side of a ship to cause generated bubbles to remain at the bottom side thereof, and thus reduce frictional resistance to water, so that an increase in sailing speed and an improvement in fuel efficiency are promoted. The present invention suctions the air generated during ship maneuvering without using a separate driving source while having a simple structure, to form, at the bottom side of the bottom of the ship, an air layer comprising air bubbles, and thus can be economically manufactured and increase operating efficiency.

### TECHNICAL FIELD

The present invention relates to a ship resistance reduction apparatus using an air during ship operation, and more particularly, a ship resistance reduction apparatus using an air which sprays air at the bottom side of a ship to cause generated bubbles to remain at the bottom side thereof and thus reduces frictional resistance against the water to improve the speed.

### BACKGROUND ART

Generally, a ship refers to a transportation facility which floats and sails on the water and is classified into rowboats, sailboats (wind power), steam boats (mechanical power fueled by coal and oil), and nuclear power ships (mechanical power by nuclear fuel) depending on a power engine. Currently, the name of a steamship is used to mean a power ship propelled by mechanical power regardless of its type. However, the steamship in a narrow sense refers to a ship having a reciprocating engine or a steam turbine engine operated by steam power and an internal combustion steamship with a gasoline engine, a suction gas engine, a hot valve engine, and a diesel engine is called as a steamship to be distinguished.

In terms of propellers, early steamships were waterwheel type paddle steamers, but in modern times, screw propeller ships configured by propellers with 3 to 7 blades were mainly used. The screw propeller is usually a propeller with 3 to 7 blades and a spiral surface of the propeller blade pushes the water and the thrust generated by the reaction to move the ship forward. As a typical ship propeller device, single propellers such as a fixed pitch propeller (FPP) and a controllable pitch propeller (CPP) and compound propellers such as contra-rotating propeller (CRP) and a tandem propeller may be used.

Even though the screw propeller which is a traditional ship propeller device is being developed in accordance with the trend of the high speed and large size ships, problems of vibrations and noises due to cavitation generated as the ship speeds up are caused. At this time, the cavitation refers to a phenomenon that occurs when a propeller with a high load is configured at a rotational speed exceeding a certain critical rotational speed and more generally, a phenomenon that bubbles filled with water vapor and air are visualized and grow by lowering the pressure at a certain temperature.

In addition, when the ship sails on the sea surface, energy loss may occur due to various causes. Representatively, a wave making resistance which is configured by a divergent wave which is generated by splitting water at the bow of the hull and a transverse wave which follows the divergent wave and is perpendicular to the divergent wave to generate resistance in all parts of the hull, a frictional resistance which is divided into a surface frictional resistance and a shape resistance and impedes the progress of the hull due to the viscosity of the water, an eddy making resistance by which water does not flow smoothly along the hull surface, and an aerodynamic resistance which is generated from the hull and the superstructure exposed on the water surface.

For various resistances generated during the ship operation, various methods such as a steamlined design, a wave piercing design, and a multi-carrier design are applied. For example, a method of designing a bow part in the form of a bulbous bow is applied for the wave making resistance, a steamlined design in which a front surface of a floating body is made at a small angle with the steamline if possible and a rear surface is narrowed so that the steamline does not fall off is applied for the eddy making resistance. Further, for the frictional resistance, in order to reduce the frictional resistance against the sea water, a method of reducing an area which is in contact with the water and using many specific paints which reduce the resistance is applied. Further, for the aerodynamic resistance, a structure above the sea surface is changed from a rectangular shape to a circular shape and an empty space is prepared in the middle of the structure to reduce the air resistance.

Recently, as one of methods for reducing the resistance during the ship operation, a ship resistance reduction method which disposes an air cavity which is an air layer on a hull surface to reduce an energy loss due to the viscosity with the sea water by the air layer is consistently being studied and developed.

As the related arts, Korean Registered Patent No. 10-1980738 discloses water-jet type air lubrication device for reducing frictional resistance of a ship, Korean Registered Patent No. 10-2031829 discloses small ship with improved resilience due to buoyancy enhancement, and Korean Registered Patent No. 10-1433525 discloses air lubrication ship which places an air production device in the hull and places an air spraying device in a longitudinal direction from the bow of the ship bottom to the stern to sufficiently cover the ship bottom with sprayed air.

However, the air lubrication device of a ship according to the related art has a problem in that in order to supply a large amount of air to the air spraying device, a power consumption cost according to the operation of the air production device is increased. Further, there is another problem in that during the sailing, the ship rocks in the left, right, and forward, and backward directions so that the air layer is not smoothly formed and it is difficult to maintain the formed air layer.

### DISCLOSURE

### Technical Problem

The present invention has been made an effort to solve the problems of the related art and an object of the present invention is to provide a ship resistance reduction apparatus using an air which induces an air layer formed between water and the ship to stably flow from the bow to the stern even in irregular movement generated during the operation of the ship to suppress the rocking of the ship and does not use a separate air generating device to be economically manufactured and increase the convenience of the maintenance.

Another object of the present invention is to provide a ship resistance reduction apparatus using an air in which in order to prevent the lowering of the speed of the ship due to the increased frictional resistance and wave making resistance caused by the lifting of the bow of the high-speed ship, lifting blades are additionally configured in the stern to maintain the front and rear leveling of the ship, thereby increasing the sailing stability.

Still another object of the present invention is to provide a ship resistance reduction apparatus using an air which controls the generation of the air layer formed at the bottom surface of the ship bottom when the ship reciprocates, stops, or decelerates to increase the operation efficiency.

The objects of the present invention are not limited to the aforementioned object, and other objects, which are not mentioned above, will be apparently understood by the person skilled in the art from the following description.

### Technical Solution

In order to achieve the above-described object, a ship resistance reduction apparatus using air according to the present invention includes air intake ports which are symmetrically provided at left and right sides of a bow of a ship to suck air generated during the sailing, an air intake duct which is connected to each of the air intake ports to induce the sucked air to a lower side of a hull, a manifold which is connected to each air intake duct to be supplied with air to discharge the air to generate air bubbles on a bottom surface of a ship bottom and is configured by an inner buoyant unit disposed at a center part of a ship bottom and an outer buoyant unit disposed along an edge of the ship bottom at an outside of the inner buoyant unit; and, a plurality of guide pins which protrudes along a length direction of a hull on a bottom surface of the ship bottom with an interval and controls the air to flow in a sailing direction while suppressing the flow of the air bobbles generated in the inner buoyant unit and the outer buoyant unit to a width direction of the hull.

As a desirable feature of the present invention, in the manifold, a passage through which a sucked air flows therein is formed and discharge holes through which the sucked air is discharged to the outside are formed on a bottom surface of the passage with a predetermined interval, and a discharge guide plate is formed at one side of the discharge hole to protrude toward the passage to generate a resistance against the flow direction of the sucked air to guide the sucked air to the discharge hole to be discharged to the outside of the ship bottom.

As another desirable feature of the present invention, at least one of an air blower which is provided at one side of the air intake port to be applied with a power to perform ventilation action and a solenoid valve which is installed at one side of the air intake port to selectively suck or shut the air is provided.

As another desirable feature of the present invention, the manifold is detachably coupled to the ship bottom of the hull with a fitting structure or a screw fastening structure.

As another desirable feature of the present invention, the hull includes lifting blades which are provided at both sides of the stern to suppress the bow lifting phenomenon.

### Advantageous Effects

The ship resistance reduction apparatus using an air according to the present invention sprays air at the ship bottom which is a bottom surface of the ship to reduce the frictional resistance by the air bubbles, thereby increasing a sailing speed, and promoting the improvement in a fuel efficiency.

Further, the air generated during the sailing of the ship is sucked with a simple structure and without using a separate driving source to form an air layer formed of air bubbles on the bottom side of the ship bottom, to be economically manufactured. Further, the apparatus is detachable as needed to easily remove the attached substances such as barnacles or seaweeds so that the maintenance is convenient.

Further, according to the present invention, the air layer generated in one pair of manifolds disposed at the left and right sides is partially generated or is not generated so that the frictional force when the ship turns, decelerates, or stops is partially increased to increase the sailing efficiency.

The characteristics and advantages of the present invention will be clearer through the detailed description referring to the accompanying drawings. Prior to this, terms or words used in the specification and the claims should not be analyzed as a general and dictionary meaning and should be analyzed as a meaning and a concept which conform to the technical spirit of the present invention based on a principle that the inventor can appropriately define a concept of a term in order to describe his/her own invention by the most method.

### DESCRIPTION OF DRAWINGS

FIG. 1 is a side view illustrating a ship to which a ship resistance reduction apparatus using an air according to the present invention is applied.

FIG. 2 is a view of a ship to which a ship resistance reduction apparatus using an air according to the present invention is applied, seen from the bottom.

FIG. 3 is a view of a ship to which a ship resistance reduction apparatus using an air according to the present invention is applied, seen from the bow.

FIG. 4 is a view extracting a main part of a bottom buoyant unit of a ship resistance reduction apparatus using an air according to the present invention.

FIG. 5 is a view illustrating another exemplary embodiment of a ship resistance reduction apparatus using an air according to the present invention.

### EXPLANATION OF REFERENCE NUMERALS AND SYMBOLS

| | |
|---|---|
| 1: Ship | 2: Hull |
| 3: Bow | 4: Stern |
| 5: Ship bottom | 10: Air intake port |
| 11: Air intake duct | 13: Manifold |
| 13a: Inner buoyant unit | 13b: Outer buoyant unit |
| 15: Guide pin | 17: Discharge hole |
| 18: Air discharge guide plate | 20: Air blower |
| 21: Supply pipeline | 25: Solenoid valve |
| a: Passage | b: Air bubble |
| s: Lifting blade | |

### Best Mode

Hereinafter, a configuration and an operation of the exemplary embodiment of the present invention will be described in detail with reference to the accompanying drawings. However, it is not intended to limit the present invention to the specific embodiments, and it will be appreciated that the present invention includes all modifications, equivalences, or substitutions included in the spirit and the technical scope of the present invention. In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other specific characteristics, numbers, steps, operations, constituent elements, and components, or a combination thereof in advance. That is, throughout the specification, unless explicitly described to the contrary, the word “comprise” and variations such as “comprises” or “comprising”, will be understood to imply the inclusion of stated elements but not the exclusion of any other elements.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present invention.

Here, repeated description and detailed description for known functions and configurations which may unnecessarily obscure the gist of the present invention may be omitted to avoid the ambiguity of the gist of the present invention. Exemplary embodiments of the present invention are provided so that those skilled in the art may more completely understand the present invention. Accordingly, the shape, the size, etc., of elements in the figures may be exaggerated for explicit comprehension.

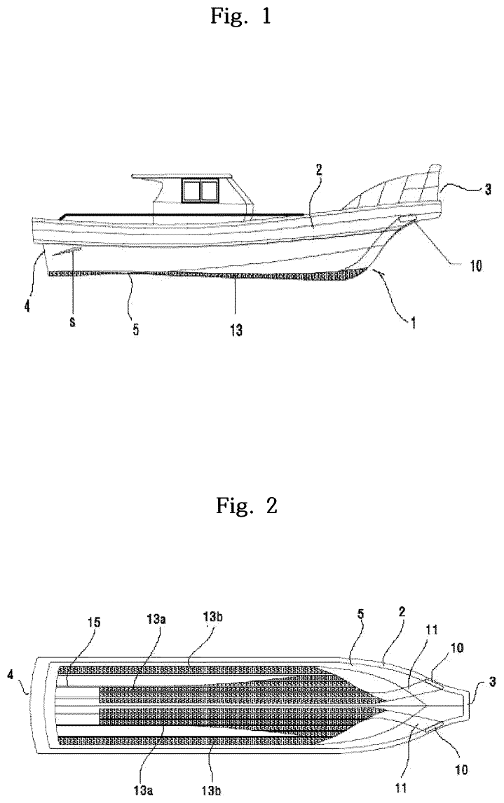

FIG. 1 is a side view illustrating a ship to which a ship resistance reduction apparatus using an air according to the present invention is applied.

In the drawing, a ship 1 configured by a bow 3 which configures a front part of the hull 2, a stern 4 which refers to a rear part of the hull 2, and a bottom 5 of the ship which refers to a bottom surface of the hull 2 is illustrated. A ship resistance reduction apparatus using an air which includes an air intake port 21 which is located at the bow 3 of the hull 2 to induce suction of a sailing wind generated during the sailing of the ship 1, an air intake duct 11 which is a pipeline for guiding air sucked through the air intake port 21 to the sea side of the hull 2, that is, to the ship bottom 5, a manifold 13 which is supplied with air introduced through the air intake duct 11 to guide the air to be divided into an inner buoyant unit 13a and an outer buoyant unit 13b, and lifting blades s which protrude from both sides of sterns 4 of the hull 2 to induce the stern 4 to be lifted by the sailing wind to compensate for the lifting of the bow 3 during the operation of the ship 1 to maintain the front and rear leveling of the ship 1 is illustrated.

FIG. 2 is a view of a ship to which a ship resistance reduction apparatus using an air according to the present invention is applied, seen from the bottom.

In the drawing, a ship bottom 5 of the hull 2 of the ship 1 is illustrated. As seen from the drawing, the air intake port 21 which induces the suction of the air by the sailing wind generated during the sailing of the ship 1 is located symmetrically to the left and right at the bow 3. A ship resistance reduction apparatus using an air which includes an air intake duct 11 which is a pipeline for guiding air sucked through the air intake port 21 to the sea side of the hull 2, that is, to the ship bottom 5, a manifold 13 which is supplied with air introduced through the air intake duct 11 to guide the air to be divided into the inner buoyant unit 13a and the outer buoyant unit 13b, and a guide pin 15 which protrudes to the lower portion of the manifold 13 along a longitudinal direction of the hull 2 to partition the hull in a width direction to suppress the flow of the air bubbles b generated from the inner buoyant unit 13a and the outer buoyant unit 13b in the width direction of the hull 2 to increase the straight stability is illustrated.

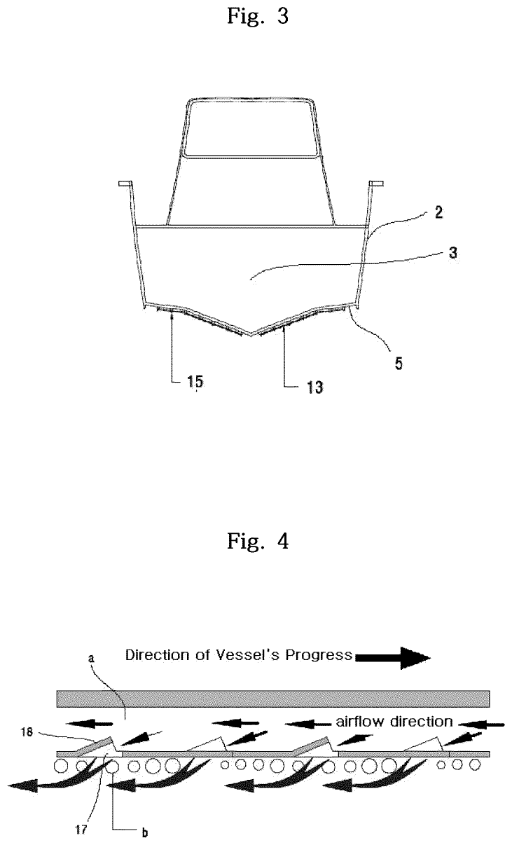

FIG. 3 is a view of a ship to which a ship resistance reduction apparatus using an air according to the present invention is applied, seen from the bow.

In the drawing, a ship provided with a manifold 13 which is integrally formed at the ship bottom 5 of the hull 2 or separately manufactured to be detachable by a screw member or a fitting structure and a plurality of guide pins 15 which protrudes and partitions in the form of a fin toward the ship bottom 5, that is, a lower side of the manifold 13 to suppress the flow in the width direction of the hull 2 of the air layer by the air bubbles b generated in the manifold is illustrated.

FIG. 4 is a view extracting a main part of a bottom buoyant unit of a ship resistance reduction apparatus using an air according to the present invention.

In the drawing, a ship resistance reduction apparatus using an air provided with a manifold 13 which is a diverging element having a passage for air flow to be supplied with an air through an air intake port 21 and an air intake duct provided at the bow 3 of the ship 1 and supply the air to be divided into the inner buoyant unit 13a and the outer buoyant unit 13b, a plurality of discharge holes 17 which configures the inner buoyant unit 13a and the outer buoyant unit 13b configuring the manifold 13 and is formed on a bottom surface of a passage through which an air sucked from the bow 3 flows toward the stern 4, and an air discharge guide plate 18 which protrudes toward the passage a from the discharge hole 17 to discharge air to the outside of the ship bottom 5 through the discharge hole 17 by generating a resistance against a flow direction of the sucked air.

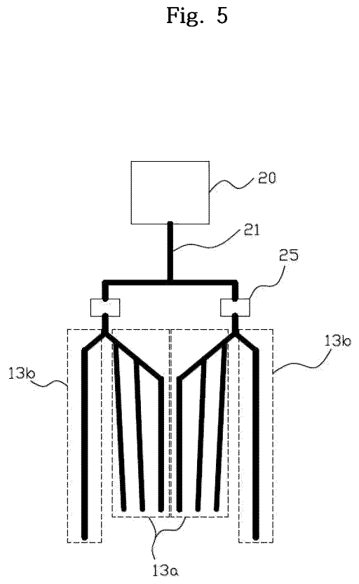

FIG. 5 is a view illustrating another exemplary embodiment of a ship resistance reduction apparatus using an air according to the present invention.

When a size of the ship is large or a sailing speed is slow, it may be difficult to smoothly suck the air through the air intake hole 21 provided at the bow of the hull 2 so that in order to compensate therefor, an air blower 20 is installed to forcibly supply the air to the air intake hole 21.

Further, a ship resistance reduction apparatus using air including a solenoid valve 25 which is installed together with the air blower 20 or independently installed to be installed in one pair of air intake ducts 11 to open and close a duct is illustrated. At this time, left and right solenoid valves 25 simultaneously open or close the duct or control the opening of the left or right air intake duct 11.

A configuration of a ship resistance reduction apparatus using an air according to the present invention will be described with reference to the drawings as follows.

Referring to FIGS. 1 to 5, the present invention is configured by air intake ports which are disposed at left and right sides of the bow 3 of the ship 1 to suck the air, an air intake duct 11 which is connected to the air intake ports 10 to guide the sucked air to the bottom side of the ship bottom 5, a manifold 13 which is connected to the air intake duct 11 to be supplied with the air to guide the air to be divided into the inner buoyant unit 13a and the outer buoyant unit 13b and forms air bubbles b while discharging the sucked air to the outside of the ship bottom 5, and a guide pin 15 which protrudes along a length direction of the ship bottom 5 to suppress the flow of the air bubbles b formed through the manifold 13 to the width direction of the hull 2.

The air intake ports 10 are symmetrically provided at left and right sides of the bow 3 which is a front part of the hull 2 of the ship 1 and guides the suction of an air resistance which is generated at the bow 3 during the operation of the ship 1. Even though the air intake port 10 is not illustrated in the drawing, the air intake port 10 is desirably provided with a filter element such as a mesh net, which prevents the introduction of foreign materials, such as organisms or other floating materials.

As a desirable embodiment, in the present invention, the air intake ports 10 are disposed at the left and right sides of the bow 3, but are not limited thereto and a separate air intake port is installed at the center of the hull 2 or at the stern 4 to induce the suction of the air.

Further, even though a natural intake structure is illustrated as the air intake port 10 in the present invention, when a sailing speed of the ship 1 is slow or wind blows in a direction opposite to the sailing direction of the ship 1, a separate air blower 20 may be used to forcibly supply the air. That is, when it is difficult to sufficiently supply the intake air to the manifold 13 only by the natural air intake according to a sailing speed of the ship 1 or a wind direction, the air may be forcibly ventilated through the air blower 20 provided at one side of the air intake port 10.

The air intake duct 11 is a pipeline element which is connected to the air intake port 10 to guide the air to the ship bottom 5 and is integrally molded with the air intake port 10. The air intake duct 11 may be integrally formed on an outer surface of the hull 2 or separately molded to be attached thereto and this structure may be embodied in various ways by the technique of the related art so that a detailed description will be omitted.

The manifolds 13 are symmetrically disposed at the left and right sides of the bottom side of the bottom of the ship and include a passage a which is connected to the air intake duct 11 of the bow 3 to be supplied with the intake air and move the intake air to the stern 4. Each manifold 13 is configured by an inner buoyant unit 13a which is longitudinally disposed along a length direction of the hull 2 at a center part of the ship bottom 5 and an outer buoyant unit 13b which is longitudinally disposed along a length direction of the hull 2 at the outside of the inner buoyant unit 13a, that is, at the outside of the ship bottom 5.

That is, the manifold 13 is configured by the inner buoyant unit 13a and the outer buoyant unit 13b and has a passage a which guides the flow of the sucked air to the inner buoyant unit 13a and the outer buoyant unit 13b.

In the meantime, the manifold 13 includes a plurality of discharge holes 17 formed with an interval to discharge the air flowing to the stern 4 along the passage a to the outside of the ship bottom 5. Further, the air discharge guide plate 18 which protrudes toward the passage a at one side of the discharge hole 17 is provided to generate a resistance against the flow direction of the sucked air is provided at one side of the discharge hole 17 to easily discharge the air through the discharge hole 17.

That is, the sucked air which flows from the front side to the rear side of the manifold 13 collides against the air discharge guide plate 18 to be discharged to the outside of the ship bottom 5 through the discharge hole 17 while generating a flow resistance and the air bubbles b are formed during the discharge process.

Guide pins 15 are a plurality of partition elements which is formed along the length direction of the hull 2 at an outer surface side of the ship bottom 5 of the hull 2 with an interval in the width direction.

That is, the guide pin 15 improves the sailing stability of the ship 1 by suppressing the flow of the air bubbles b generated in the inner buoyant unit 13a and the outer buoyant unit 13b in the width direction of the hull 2 and naturally flows the air layer formed of generated air bubbles b to the stern 4 by the operation of the ship 1 in a state confined in a partitioned space between guide pins to reduce the frictional resistance between the hull 2 and the water.

In the meantime, the guide pin 15 is desirably integrally formed on the bottom surface of the manifold 13 and the manifold 13 is detachably coupled to the ship bottom 5 of the hull 2 by a fitting structure or a screw fastening structure.

In the meantime, the present invention proposes lifting blades s provided on both sides of the stern 4. When the ship 1 sails at a high speed, the bow 3 is lifted to increase the frictional resistance, the wave making resistance, and the air resistance so that the lifting blades s act as a factor of reducing the speed of the ship 1. At this time, the lifting blades s provided on both sides of the stern 4 are applied with the buoyant force to raise the stern 4 so that the front and rear leveling of the ship 1 is maintained.

The lifting blades s are configured to be provided at an upper part of the stern 4 to be applied with the buoyant force by the air or provided at a lower part of the stern 4 to be soaked in the water to be applied with the buoyant force by the water.

In the meantime, in the present invention, one pair of solenoid valves 25 which controls the opening of the duct is installed in one pair of air intake ports 10 or air intake ducts 11. The pair of solenoid valves 25 selectively opens/closes the duct to control whether to form an air layer for the ship bottom 5 by means of one pair of manifolds 13 which are provided at the left and right sides. By doing this, when the ship 1 turns, the solenoid valves are controlled to form a local frictional force at the ship bottom 5 or when the ship 1 stops or decelerates, increase the frictional resistance of the entire ship bottom 5.

That is, when the ship 1 turns to the right, the manifold 13 located at the right side of the ship bottom 5 closes the air intake port 10 or the air intake duct 11 using the solenoid valve 25 in the corresponding position so as not to form an air layer to increase a frictional force to the right part of the ship bottom 5 and the manifold 13 located at the left side of the ship bottom 5 normally generates the air bubbles b to reduce the friction to the left part of the ship bottom 5 to make the stable turning.

Further, when the ship 1 decelerates or stops, the pair of solenoid valves 25 operates to close the air intake ports 10 or the air intake ducts 11 disposed at the left and right sides. By doing this, the pair of manifolds 13 connected to the air intake ducts 11 do not generate the air bubbles b so that consequently, the frictional resistance of the ship bottom 5 is increased to help the decelerating or stopping operation of the ship 1.

A process of using a ship resistance reduction apparatus according to the present invention configured as described above will be described below.

First, when the ship 1 operates at a constant speed, the suction of the air is induced by the air intake ports 19 disposed at the left and right sides of the bow 3 of the hull 2 to be guided to the air intake duct 11.

The sucked air guided to the air intake duct 11 is supplied to the passage a of one pair of manifolds 13 which is symmetrically provided at the left and right sides at the bottom side of the bottom 5 of the ship.

Next, the air guided to the passage a of each manifold 13 is divided to be provided to the inner buoyant unit 13a and the outer buoyant unit 13b which configure the manifold 13 and is discharged to the outside of the ship bottom 5 by the discharge holes 17 and the air discharge guide plates 18 which are formed in the inner buoyant unit 13a and the outer buoyant unit 13b to generate the air bubbles b.

The air bubbles b generated as described above form an air layer in a space partitioned by a plurality of guide pins 15 which is longitudinally disposed along the hull 2 and is disposed with intervals in the width direction of the hull 2. The air layer formed between the spaces partitioned by each guide pin increases the straight stability of the ship 1 while moving from the bow 3 to the stern 4 along the length direction of the hull 2 by restricting the movement in the width direction of the hull 2.

Further, the lifting blades s provided at both sides of the stern 4 are installed in the air or in the water so that a buoyant force by the air or water generated during the sailing of the ship 1 is applied so that consequently the phenomenon that the bow 3 of the ship 1 is lifted is reduced. As a result, the bow 3 and the stern 4 of the ship 1 maintain the level to improve the operating stability.

Further, according to the present invention, the manifold 13 provided with the guide pin 15 and the air intake duct 11 are separated from the hull 2 so that if necessary, it is removed from the hull 2 to easily remove the attached substances such as barnacles, sea lavers, seaweeds.

In the meantime, the present invention is not limited to the exemplary embodiments described herein, and may be employed by changing a part to which the exemplary embodiment is applied, and it would be appreciated by those skilled in the art that various changes and modifications might be made to these embodiments without departing from the spirit and the scope of the invention. Therefore, such changes and modifications may be considered to belong to the claims of the present invention.

1. A ship resistance reduction apparatus using air, comprising:
air intake ports which are symmetrically provided at left and right sides of a bow of a ship to suck air generated during the sailing;
an air intake duct which is connected to each of the air intake ports to induce the sucked air to a lower side of a hull;
a manifold which is connected to each air intake duct to be supplied with air to discharge the air to generate air bubbles on a bottom surface of a ship bottom and is configured by an inner buoyant unit disposed at a center part of a ship bottom and an outer buoyant unit disposed along an edge of the ship bottom at an outside of the inner buoyant unit; and
a plurality of guide pins which protrudes along a length direction of a hull on a bottom surface of the ship bottom with an interval and controls the air to flow in a sailing direction while suppressing the flow of the air bobbles generated in the inner buoyant unit and the outer buoyant unit to a width direction of the hull.

2. The ship resistance reduction apparatus using air of claim 1, wherein in the manifold, a passage through which a sucked air flows therein is formed and discharge holes through which the sucked air is discharged to the outside are formed on a bottom surface of the passage with a predetermined interval, and a discharge guide plate is formed at one side of the discharge hole to protrude toward the passage to generate a resistance against the flow direction of the sucked air to guide the sucked air to the discharge hole to be discharged to the outside of the ship bottom.

3. The ship resistance reduction apparatus using air of claim 1, further comprising: at least one of
an air blower which is provided at one side of the air intake port to be applied with a power to perform ventilation action and a solenoid valve which is installed at one side of the air intake port to selectively suck or shut the air.

4. The ship resistance reduction apparatus using air of claim 1, wherein the manifold is detachably coupled to the ship bottom of the hull with a fitting structure or a screw fastening structure.

5. The ship resistance reduction apparatus using air of claim 1, wherein the hull includes lifting blades which are provided at both sides of the stern to suppress the bow lifting phenomenon.
